(19) United States
(12) Patent Application Publication
(10) Pub. No.: US 2025/0165942 A1
(43) Pub. Date: May 22, 2025

(54) FEEDBACK FOR DIFFERENT TRANSACTION TYPES

(71) Applicant: Motorola Mobility LLC, Chicago, IL (US)

(72) Inventors: Krishnan Raghavan, Bangalore (IN); Vignesh Karthik Mohan, Bangalore (IN); Nakul Patel, Bangalore (IN)

(73) Assignee: Motorola Mobility LLC, Chicago, IL (US)

(21) Appl. No.: 18/517,969

(22) Filed: Nov. 22, 2023

(51) Int. Cl. G06Q 20/12

(52) U.S. Cl. CPC G06Q 20/12

(57) ABSTRACT

Techniques for feedback for different transaction types are described and are implementable to enable transaction feedback for data transactions to be transformed into other forms of feedback, such as fulfillment feedback for fulfillment transactions. For instance, a transaction service receives transaction feedback for a data transaction. The transaction service communicates the transaction feedback to a fulfillment service, and the fulfillment services transforms the transaction feedback into a different data form to generate fulfillment feedback for a corresponding fulfillment transaction.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without challenges. For instance, financial transactions can include multiple stages such that providing user feedback at each stage of a transaction may be cumbersome and/or infeasible.

### BRIEF DESCRIPTION OF THE DRAWINGS

Aspects of feedback for different transaction types are described with reference to the following Figures. The same numbers may be used throughout to reference similar features and components shown in the Figures. Further, identical numbers followed by different letters reference different instances of features and components described herein.

FIG. 1 illustrates an example environment in which aspects of feedback for different transaction types can be implemented.

FIG. 2 depicts aspects of an example system for feedback for different transaction types in accordance with one or more implementations.

FIG. 3 depicts aspects of an example system for feedback for different transaction types in accordance with one or more implementations.

FIG. 4 depicts an example transaction feedback graphical user interface in accordance with one or more implementations.

FIG. 5 depicts an example transaction GUI in accordance with one or more implementations.

FIG. 6 depicts the example transaction GUI in accordance with one or more implementations.

FIG. 7 depicts the example transaction GUI in accordance with one or more implementations.

FIG. 8 depicts an example fulfillment GUI in accordance with one or more implementations.

FIG. 9 depicts an example of the fulfillment GUI in accordance with one or more implementations.

FIG. 10 illustrates a flow chart depicting an example method for feedback for different transaction types in accordance with one or more implementations.

FIG. 11 illustrates a flow chart depicting an example method for feedback for different transaction types in accordance with one or more implementations.

FIG. 12 illustrates a flow chart depicting an example method for feedback for different transaction types in accordance with one or more implementations.

FIG. 13 illustrates various components of an example device in which aspects of feedback for different transaction types can be implemented.

### DETAILED DESCRIPTION

Techniques for feedback for different transaction types are described and are implementable to enable transaction feedback regarding data transactions to be utilized to automatically generate fulfillment feedback for corresponding fulfillment transactions. For instance, a user can provide transaction feedback for different data transactions, such as for purchase transactions tracked by a transaction application, e.g., a finance-related application. When transaction feedback for a data transaction is provided, the transaction feedback can be utilized to automatically generate fulfillment feedback for a corresponding fulfillment transaction.

As an example, consider a scenario where a user utilizes a fulfillment application on a client device to interact with a fulfillment service and implement a fulfillment transaction. The fulfillment transaction, for example, represents a purchase of a product, such as goods and/or services. A data transaction is implemented in conjunction with the fulfillment transaction, such as to provide data representing monetary value in exchange for a product as part of the fulfillment transaction. Further to the example scenario, a transaction application that tracks the data transaction enables the user to provide transaction feedback for the data transaction, such as to rate a relative user satisfaction with the data transaction. The transaction feedback can be mapped to the fulfillment transaction to automatically generate fulfillment feedback for the corresponding fulfillment transaction. For instance, the transaction feedback can be transformed into a data form used by the fulfillment service to generate the fulfillment feedback. Further, the fulfillment feedback can be output such as by a fulfillment application used to implement at least a portion of the fulfillment transaction.

Accordingly, techniques described herein enable transaction feedback to be automatically converted into fulfillment feedback for associated fulfillment transactions. In one or more implementations a data transaction represents a digital payment transaction. For instance, digital payment transactions involve generating, transmitting, and processing various types of data across a variety of different systems and networks. Thus, such digital payment transactions can be characterized as sets of computational operations much like other operations of a computing device and/or set of computing devices. Accordingly, by enabling user feedback regarding data transactions to be automatically converted into feedback for fulfillment transactions, the described techniques can conserve user and system resources (e.g., memory, processor bandwidth, network bandwidth, etc.) that may otherwise be used to manually provide feedback for fulfillment transactions, and thus the described techniques can improve the operation of computing devices and data networks.

While features and concepts of feedback for different transaction types can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

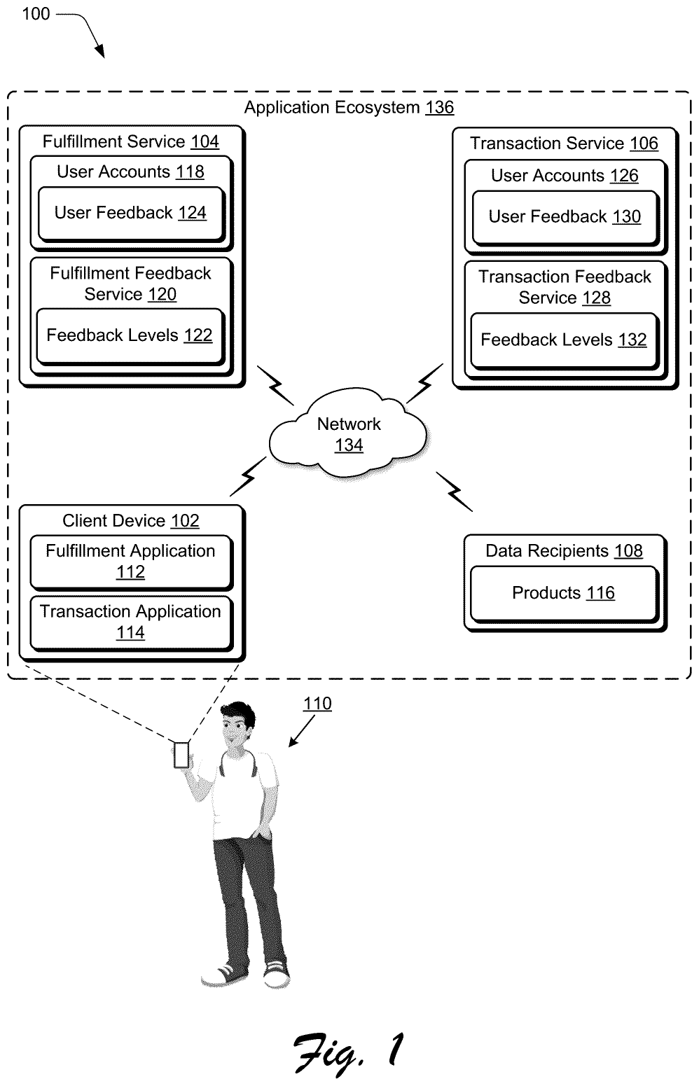

FIG. 1 illustrates an example environment 100 in which aspects of feedback for different transaction types can be implemented. The environment 100 includes a client device 102, a fulfillment service 104, a transaction service 106, and data recipients 108. The client device 102 represents a device that can be used by a user 110 to perform and manage different transactions, e.g., such as fulfillment transactions, data transactions, finance transactions such as purchasing goods and services, and combinations thereof. Examples of the client device 102 include mobile devices such as mobile phones, wearable devices, extended reality (XR) devices, tablets, laptops, etc. The client device 102, however, may be implemented in other ways, such as a desktop computing device, a server device, etc.

The client device 102 includes different functionalities that enable aspects of feedback for different transaction types including a fulfillment application 112 and a transaction application 114. The fulfillment application 112 represents an application that enables a user 110 of the client device 102 to engage in different fulfillment transactions, such as purchases of products, e.g., goods and/or services. The fulfillment application 112, for example, can interface with fulfillment service 104 to perform fulfillment transactions. In implementations the fulfillment service 104 represents a network-based service that is accessible to the client device 102 such as via the fulfillment application 112 to enable the user 110 of the client device 102 to engage in different fulfillment transactions.

The transaction application 114 represents functionality for enabling the client device 102 to engage in different data transactions, such as managing the transfer of different types of data. In at least one example the transaction service 106 facilitates the transfer of data representing value (e.g., monetary and/or other types of value) as part of facilitating fulfillment transactions between the fulfillment application 112 of the client device 102 and the fulfillment service 104.

The transaction service 106 can be implemented by various entities, such as a banking entity, a payment service, an enterprise entity, a trading entity, a data storage and/or management entity, and/or combinations thereof. The user 110, for instance, can utilize a transaction application 114 on the client device 102 to access the transaction service 106 to perform different finance transactions, such as to transfer value amounts (e.g., monetary values) for different purposes, e.g., to purchase goods and services. The transaction application 114, for example, represents functionality that enables various finance-related transactions to be performed via the client device 102, including access to the transaction service 106.

The data recipients 108 represent entities with which the client device 102 may engage in fulfillment transactions and/or data transactions. For instance, the user 110 can utilize the fulfillment application 112 to engage in a fulfillment transaction with a data recipient 108 and which is facilitated by the fulfillment service 104. Further, an exchange of data (e.g., data representing value) as part of the fulfillment transaction can be enabled via the transaction service 106.

For example, the data recipients 108 via the fulfillment service 104 can provide products 116 (e.g., goods and/or services) to the user 110 and in exchange the client device 102 can cause a transfer of data via the transaction service 106 (e.g., data representing an exchange of value) to the data recipients 108. In at least one implementation the data exchange between the client device 102 and the data recipients 108 is facilitated (e.g., managed) by the transaction service 106. The transaction service 106, for example, can implement a transfer of data (e.g., a data representation of value such as monetary value) to the data recipients 108 on behalf of the client device 102.

The fulfillment service 104 includes functionality for implementing various aspects of feedback for different transaction types including user accounts 118 and a fulfillment feedback service 120. The user accounts 118 include information for different instances of users, such as fulfillment transactions performed by different users. The user accounts 118, for example, include a user account 118 for the user 110. The fulfillment feedback service 120 represents a service that enables users to provide feedback for different fulfillment transactions implemented via the fulfillment service 104. For instance, when the client device 102 engages in a fulfillment transaction with a data recipient 108 (e.g., an exchange of value for a product 116 provided by the data recipient 108), the user 110 can utilize the client device 102 to provide feedback to the fulfillment feedback service 120 regarding the fulfillment transaction. The feedback, for instance, can include data that identifies how the user 110 “rates” the data transaction, e.g., as a positive transaction, a satisfactory transaction, a negative transaction, etc.

Accordingly, in one or more implementations, the fulfillment feedback service 120 includes different feedback levels 122 which represent different categorizations of fulfillment transactions. The feedback levels 122, for example, include different predefined selectable categorizations that indicate a relative user feedback regarding instances of fulfillment transactions. In an example implementation the feedback levels 122 can be based on a scale of 1-10 with 1 indicating an extreme user dissatisfaction with a data transaction and 10 indicating an extreme user satisfaction with a data transaction. In another example, the feedback can be a bipolar scale such as good or bad (or like/dislike). According to implementations, user feedback regarding fulfillment transactions can be stored in corresponding user accounts 118 as user feedback 124.

The transaction service 106 includes functionality for implementing various aspects of feedback for different transaction types including user accounts 126 and a transaction feedback service 128. The user accounts 126 includes information for different instances of users, such as data transactions performed by different users. For instance, the user accounts 126 can track data transactions performed by different users in conjunction with corresponding fulfillment transactions with the fulfillment service 104. The user accounts 126, for example, include a user account 126 for the user 110.

The transaction feedback service 128 represents a service that enables feedback to be associated with different data transactions implemented via the transaction service 106. For instance, the transaction feedback service 128 enables users to provide transaction feedback to be provided regarding different data transactions, which can be stored as user feedback 130. Further, the transaction feedback service 128 includes different feedback levels 132 which represent different categorizations of data transactions. The feedback levels 132, for example, include different predefined categorizations that indicate a relative user feedback regarding instances of data transactions. According to implementations user feedback regarding data transactions can be stored in corresponding user accounts 126 as the user feedback 130.

According to implementations, when the user 110 provides user feedback 130 to the transaction service 106 for a data transaction, the user feedback 130 can be communicated to the fulfillment service 104 for association with a corresponding fulfillment transaction as user feedback 124. Thus, at least some of the user feedback 124 can be associated with fulfillment transactions of the fulfillment service 104 that are based on corresponding data transactions of the transaction service 106.

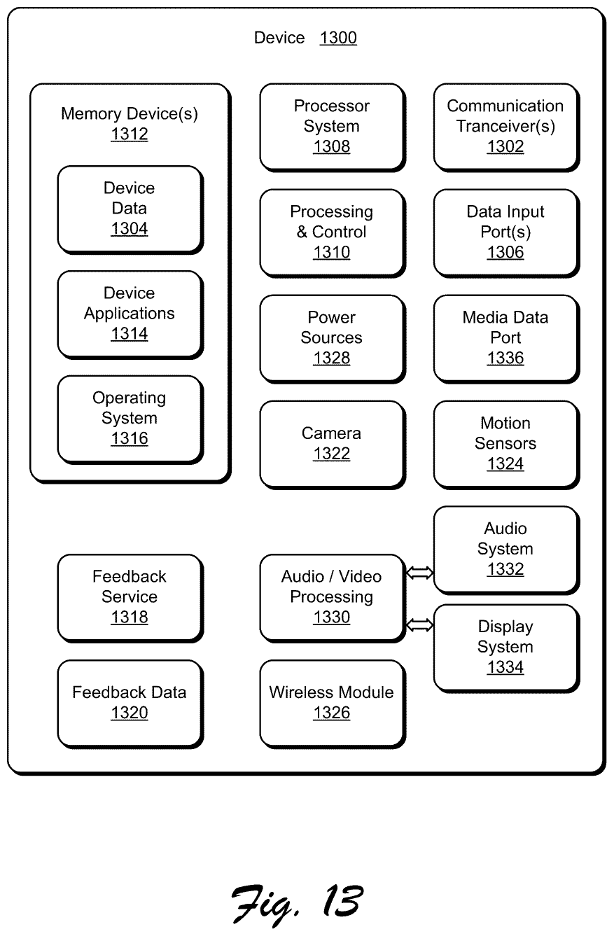

The client device 102, the fulfillment service 104, the transaction service 106, and/or the data recipients 108 can be implemented in various ways and include various functionality, examples of which are discussed below with reference to the example device 1300 of FIG. 13. Further, various entities of the environment 100 can be connected and communicate via a network 134. The network 134, for example, can represent a combination of wired and wireless networks via which the client device 102, the fulfillment service 104, the transaction service 106, and/or the data recipients 108 can participate in various types of communication, such as wired and/or wireless data communication.

According to implementations various entities of the environment 100 (e.g., the fulfillment application 112 and the fulfillment service 104, and the transaction application 114 and the transaction service 106) can be implemented at least in part in the context of an application ecosystem 136 that provides for intercommunication and interoperability of the various entities. The application ecosystem 136, for instance, represents a network infrastructure of functionality (e.g., devices and logic) that enables the various entities to cooperatively perform different types of transactions. In at least one implementation the application ecosystem 136 represents a super application (e.g., super-app, super app, and/or superapp) that integrates functionalities of the various entities to provide for more efficient and seamless performance of different transactions, such as the fulfillment transactions and data transactions discussed herein.

Having discussed an example environment in which the disclosed techniques can be performed, consider now some example scenarios and implementation details for implementing the disclosed techniques.

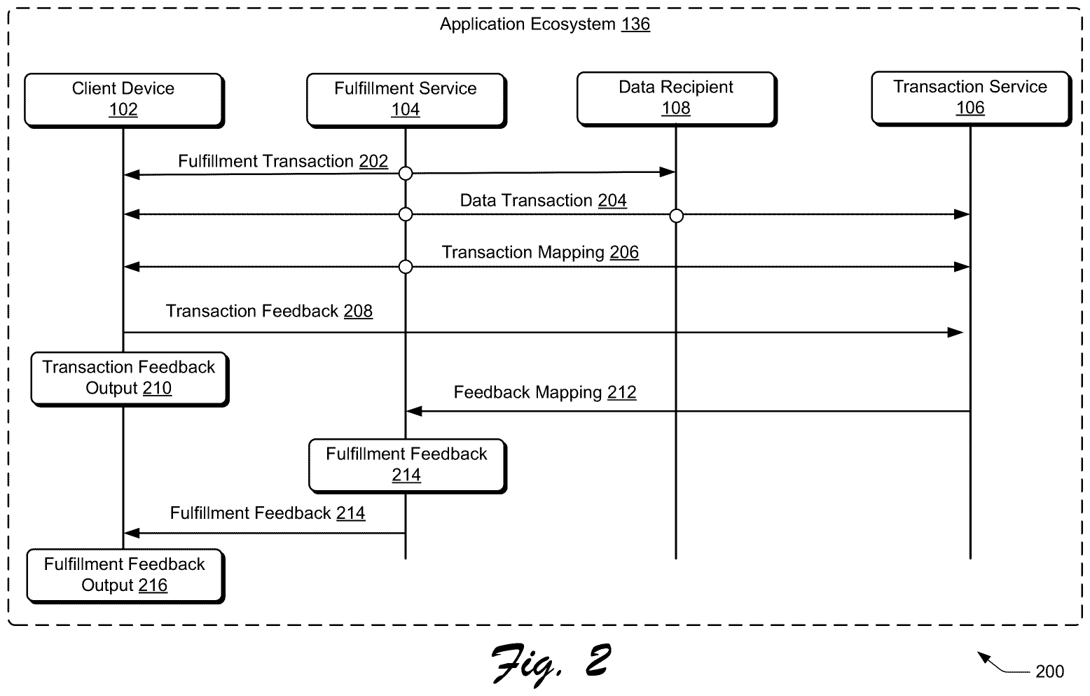

FIG. 2 depicts aspects of an example system 200 for feedback for different transaction types in accordance with one or more implementations. The system 200 can be implemented in the environment 100 and incorporates attributes of the environment 100 introduced above. Further, various operations and communications discussed in the system 200 can be implemented via the application ecosystem 136, such as via intermediate entities (e.g., devices) that implement and/or manage the application ecosystem 136. In the system 200, the client device 102 engages in a fulfillment transaction 202 with a data recipient 108. The fulfillment transaction 202 can represent various types of data-based transactions, such as an exchange of data, a purchase transaction (e.g., a purchase of a product), and combinations thereof. In at least one implementation, the fulfillment transaction 202 involves a provision of a product 116 by the data recipient 108 to the user 110 of the client device 102.

Further to the system 200, the fulfillment transaction 202 is implemented via the fulfillment service 104. The fulfillment service 104, for instance, represents a network-based portal via which different fulfillment transactions can be performed. Further, in conjunction with the fulfillment transaction 202, a data transaction 204 is implemented via the transaction service 106. For instance, the client device 102, the fulfillment service 104, the data recipient 108, and the transaction service 106 participate in the data transaction 204 which involves a transfer of data (e.g., data representing value) from the transaction service 106 to the data recipient 108. For example, in the context of a finance transaction and as part of the data transaction 204, the transaction service 106 transfers a data representation of value (e.g., monetary value, digital currency, etc.) on behalf of the client device 102 to the data recipient 108 for the fulfillment transaction 202.

According to implementations, a transaction mapping 206 is implemented which maps the data transaction 204 to the fulfillment transaction 202. For instance, the fulfillment transaction 202 is associated with a first transaction identifier mapped to another transaction identifier of the data transaction 204. This can enable various actions and/or data associated with the data transaction 204 to be associated with the fulfillment transaction 202.

Continuing with the system 200 transaction feedback 208 for the data transaction 204 is provided via the client device 102 to the transaction service 106. The user 110, for instance, interacts with the transaction application 114 to provide user feedback 130 regarding the data transaction 204. The transaction application 114 can perform transaction feedback output 210 to output the transaction feedback 208 via the client device 102. The system 200 can perform feedback mapping 212 to map the transaction feedback 208 for the data transaction 204 to the fulfillment transaction 202 and to enable the fulfillment service 104 to generate fulfillment feedback 214 for the fulfillment transaction 204. The fulfillment feedback 214, for instance, represents feedback for the fulfillment transaction 202 and is based at least in part on transaction feedback 208.

In at least one implementation, the fulfillment feedback 214 can be generated by converting the transaction feedback 208 from a feedback type used by the transaction service 106 into a different feedback type used by the fulfillment service 104. The fulfillment service 104 communicates the fulfillment feedback 214 to the client device 102 and the client device 102 can perform fulfillment feedback output 216. The fulfillment application 112, for instance, can output an indication of the fulfillment transaction 202 and the fulfillment feedback 214 for the fulfillment transaction 202.

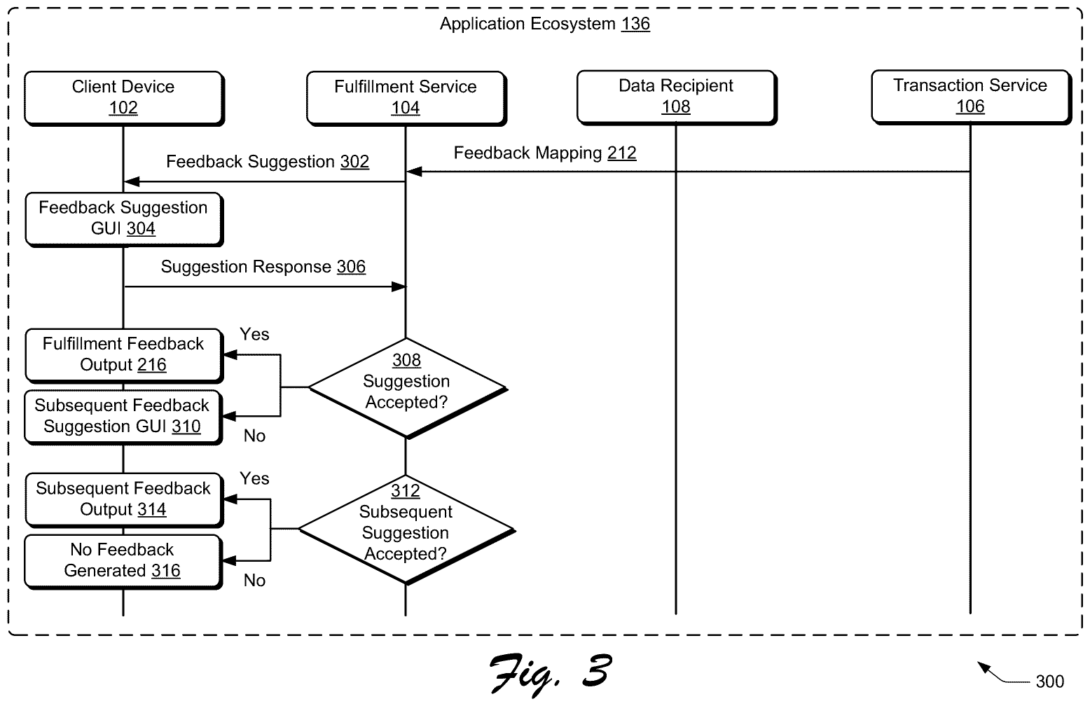

FIG. 3 depicts aspects of an example system 300 for feedback for different transaction types in accordance with one or more implementations. The system 300 can be implemented in the environment 100 and incorporates attributes of the environment 100 introduced above. Further, various operations and communications discussed in the system 300 can be implemented via the application ecosystem 136, such as via intermediate entities (e.g., devices) that implement and/or manage the application ecosystem 136. In at least some implementations, the system 300 represents an alternative and/or additional implementation to the system 200.

In system 300, feedback mapping 212 for mapping the transaction feedback 208 for the data transaction 204 to the fulfillment transaction 202 is performed, such as described above. The fulfillment service 104 transmits a feedback suggestion 302 to the client device 102 suggesting adding fulfillment feedback for the fulfillment transaction 202 based on the transaction feedback 208. Based on the feedback suggestion 302 the client device 102 outputs a feedback suggestion GUI 304 that prompts the user 110 to add fulfillment feedback based on the transaction feedback 208. User 110 provides input to the feedback suggestion GUI 304 to generate a suggestion response 306 and the suggestion response 306 is transmitted to the fulfillment service 104. The suggestion response 306, for example, includes data that indicates whether the user 110 accepts or declines the feedback suggestion 302 to generate fulfillment feedback based on the transaction feedback 208.

At 308 it is determined whether the suggestion response 306 indicates whether the user 110 accepts or declines the feedback suggestion 302. If the user accepts the feedback suggestion 302 (“Yes”), the client device 102 performs the fulfillment feedback output 216, such as discussed above. If the user declines the feedback suggestion 302 (“No”), at 310 the client device 102 presents a subsequent feedback suggestion GUI 310 that presents an opportunity for the user 110 to link the transaction feedback 208 to the fulfillment transaction 202. For instance, the subsequent feedback suggestion GUI 310 can be presented when the user 110 launches the fulfillment application 112 via the client device 102 at a subsequent time. In at least one implementation the subsequent feedback suggestion GUI 310 can be output as part of and/or in conjunction with a GUI of the fulfillment application 112.

Further to the system 300, at 312 it is determined whether the subsequent feedback suggestion is accepted. If the subsequent feedback suggestion is accepted (“Yes”), at 314 the client device 102 performs subsequent feedback output 314 to output the provided subsequent fulfillment feedback. If the subsequent feedback suggested is not accepted (“No”), at 316 no fulfillment feedback is generated for the fulfillment transaction 202.

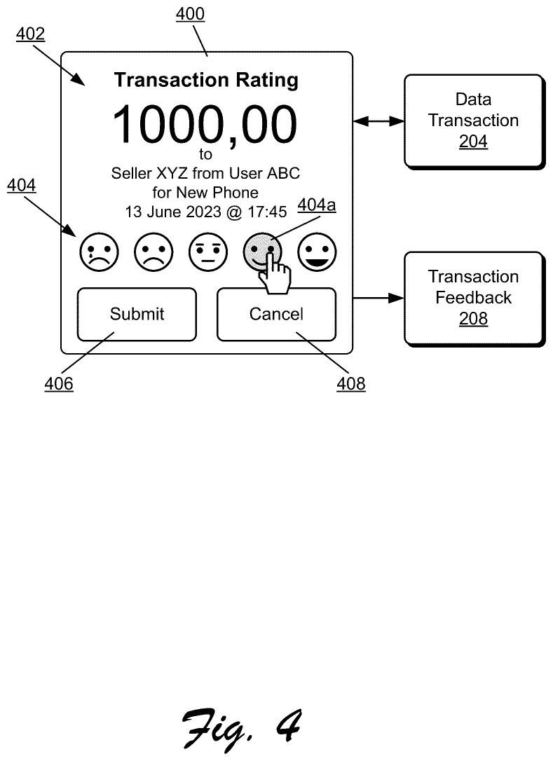

FIG. 4 depicts an example transaction feedback graphical user interface (GUI) 400 in accordance with one or more implementations. The transaction feedback GUI 400, for instance, is presented via the client device 102 and enables a user to view information about the data transaction 204 and to provide transaction feedback regarding the data transaction 204.

According to one or more implementations, the transaction feedback GUI 400 may be generated and/or managed by the transaction feedback service 128 of the transaction service 106. Further, the transaction feedback GUI 400 may be presented after completion of the data transaction 204, such as within a threshold time period after completion of the data transaction 204 and/or after the threshold time period after completion of the data transaction 204.

The transaction feedback GUI 400 includes a transaction information field 402, feedback indicia 404, a submit control 406, and a cancel control 408. The transaction information field 402 includes various information about the data transaction 204. For instance, in the context of a finance transaction, the transaction information field 402 identifies a value amount of the data transaction 204.

Further, the transaction information field 402 identifies a receiver entity of the data transaction 204 (e.g., a data recipient 108), a transferring entity for the data transaction 204 (e.g., the user 110 and/or a user account associated with the user 110), a date and time at which the data transaction 204 is initiated and/or completed, and so forth.

The feedback indicia 404 includes different feedback indicia that are selectable to provide transaction feedback regarding the data transaction 204. For instance, each of the feedback indicia 404 represents a respective feedback value, e.g., based on a defined feedback value scale. In at least one implementation feedback values correspond to a different indications of user sentiment regarding the data transaction 204. In this example, user 110 selects a feedback indicia 404a, which represents a high feedback value (e.g., high user sentiment such as high user satisfaction) regarding the data transaction 204.

The submit control 406 is selectable to cause transaction feedback input to the transaction feedback GUI 400 to be submitted (e.g., to the transaction service 106) and the cancel control 408 is selectable to cause the transaction feedback GUI 400 to be removed, e.g., canceled. For instance, the user 110 selects the feedback indicia 404a and the submit control 406, which can cause the transaction feedback 208 to be communicated to the transaction feedback service 128 and associated with the data transaction 202. The transaction feedback 208, for instance, includes a feedback value represented by the feedback indicia 404a.

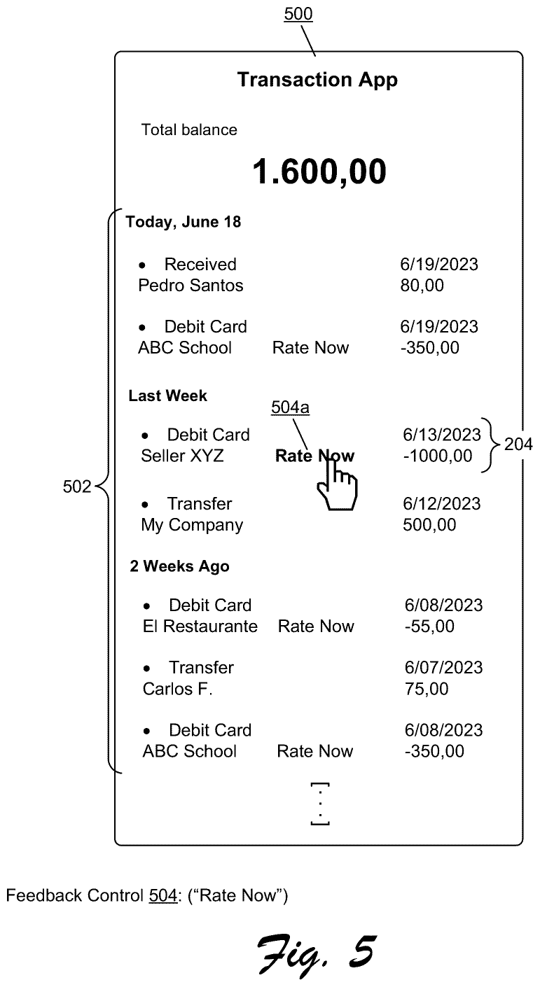

FIG. 5 depicts an example transaction GUI 500 in accordance with one or more implementations. The transaction GUI 500, for instance, is presented via the client device 102 and enables a user to view information about different data transactions (e.g., including data transaction 204) and to provide transaction feedback regarding the data transactions.

The transaction GUI 500 includes a transactions region 502 that identifies different data transactions, such as data transactions that have occurred over a period. Each of the data transactions identified in the transactions region 502 includes information about a respective data transaction, such as a data transaction source, a recipient, a date, a data transaction amount, etc.

At least some of the data transactions identified in the transactions region 502 include a respective feedback control 504 that is selectable to enable transaction feedback to be provided regarding a respective data transaction. In this example, user 110 selects a feedback control 504a to enable them to provide transaction feedback regarding the data transaction 204.

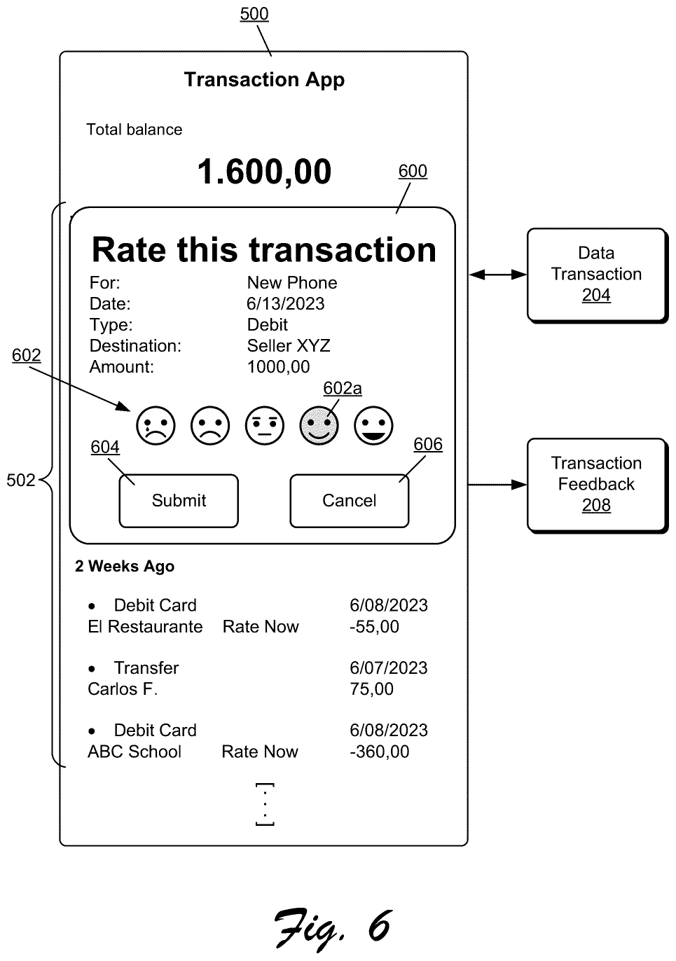

FIG. 6 depicts the example transaction GUI 500 in accordance with one or more implementations. In this example, and in response to selection of the feedback control 504a such as described above in the transaction GUI 500, a feedback GUI 600 is output that includes information about the data transaction 204, feedback indicia 602, a submit control 604, and a cancel control 606. The feedback indicia 602 includes different feedback indicia that are selectable to provide the transaction feedback 208 regarding the data transaction 204. For instance, each of the feedback indicia 602 represents a respective feedback value, e.g., based on a defined feedback value scale. In at least one implementation feedback values correspond to a different indications of user sentiment regarding the data transaction 204. In this example, user 110 selects a feedback indicia 602a, which represents a medium feedback value (e.g., medium user sentiment) regarding the data transaction 204.

The submit control 604 is selectable to cause transaction feedback input to the transaction feedback GUI 600 to be submitted (e.g., to the transaction feedback service 128) and the cancel control 606 is selectable to cause the transaction feedback GUI 600 to be removed, e.g., canceled. For instance, the user 110 selects the feedback indicia 602a and the submit control 604, which can cause the transaction feedback 208 to be communicated to the transaction feedback service 128 and associated with the data transaction 204. The transaction feedback 208, for instance, includes a feedback value represented by the feedback indicia 602a.

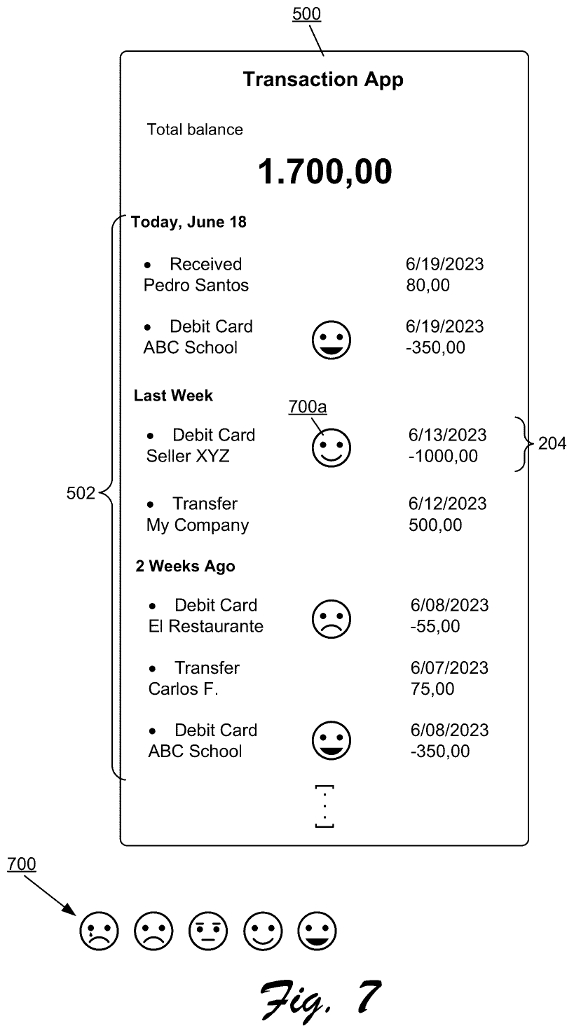

FIG. 7 depicts the example transaction GUI 500 in accordance with one or more implementations. The transaction GUI 500 presented in FIG. 7, for instance, represents a summary view of data transactions and transaction feedback regarding the data transactions. As discussed above, the transaction GUI 500 can be presented via the client device 102 and enables a user to view information about different data transactions, e.g., the data transaction 204. In this example the transactions region 502 includes different feedback indicia 700 for some data transactions identified in the transactions region 502. The feedback indicia 700, for instance, identify different user feedback provided for different data transactions identified in the transactions region 502. Different ways for determining and generating the feedback indicia 700 are described throughout this disclosure.

For instance, for the data transaction 204, the transactions region 502 includes a feedback indicia 700a that identifies transaction feedback provided for the data transaction 204, such as described above with reference to FIGS. 4-6. The feedback indicia 700a, for example, is presented based at least in part on user selection of the feedback indicia 602a as described above with reference to FIG. 6.

In at least one implementation the feedback indicia 700 are selectable to modify transaction feedback previously provided for respective data transactions. For instance, the feedback indicia 700a is selectable to cause the feedback GUI 600 to be presented via which the user 110 can select a different feedback indicia 602 to update transaction feedback regarding the data transaction 204. The updated transaction feedback can be communicated to the transaction service 106 and utilized to generate an updated transaction GUI 500 which reflects the updated transaction feedback for the data transaction 204.

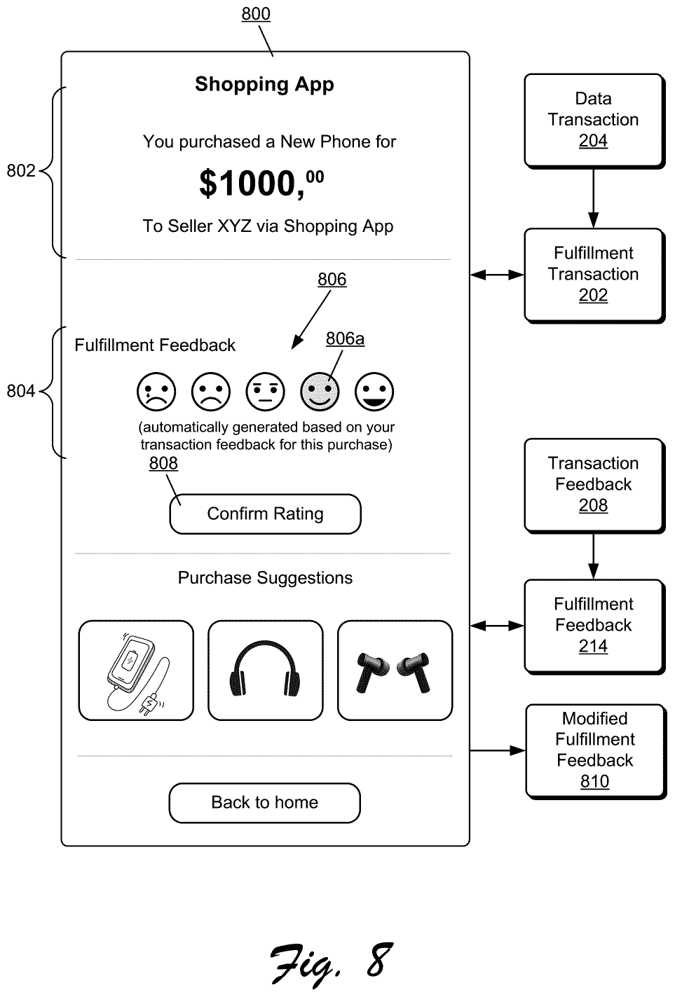

FIG. 8 depicts an example fulfillment GUI 800 in accordance with one or more implementations. The fulfillment GUI 800, for instance, is presented via the fulfillment application 112 on the client device 102 and includes various information about the fulfillment transaction 202.

The fulfillment GUI 800 includes fulfillment details 802 and a fulfillment feedback region 804. The fulfillment details 802 include various information about the fulfillment transaction 202 and the fulfillment feedback region 804 includes a description of the fulfillment feedback 214. The fulfillment feedback 214, for instance, is generated by converting the transaction feedback 208 into a feedback form utilized by the fulfillment service 104 and inserting the fulfillment feedback into the fulfillment GUI 800.

The fulfillment feedback region 804 includes feedback indicia 806 that each indicate different feedback values that can be applied to the fulfillment transaction 202. In this example, the feedback indicia 806 includes an indicator 806a representing fulfillment feedback 214. The feedback indicator 806a, for example, represents a visual representation of a conversion of the transaction feedback 208 to generate the fulfillment feedback 214.

In at least one implementation the fulfillment feedback region 804 can specify that the feedback indicator 806a is automatically generated based on the transaction feedback 208. Further, the fulfillment feedback region 804 includes a confirm control 808 that is selectable to confirm that a feedback value associated with the feedback indicator 806a is to be applied to the fulfillment transaction 202 to generate the fulfillment feedback 214.

According to implementations the different feedback indicia 806 are selectable to modify the automatically generated fulfillment feedback 214. For instance, the user 110 can select a different feedback indicia 806 (e.g., other than the feedback indicator 806a) to modify the fulfillment feedback 214 and generate modified fulfillment feedback 810. The modified fulfillment feedback 810, for instance, can be applied to the fulfillment transaction 202.

Accordingly, the user 110 can select the confirm control 808 to cause the fulfillment feedback 214 or the modified fulfillment feedback 810 to be applied to the fulfillment transaction 202.

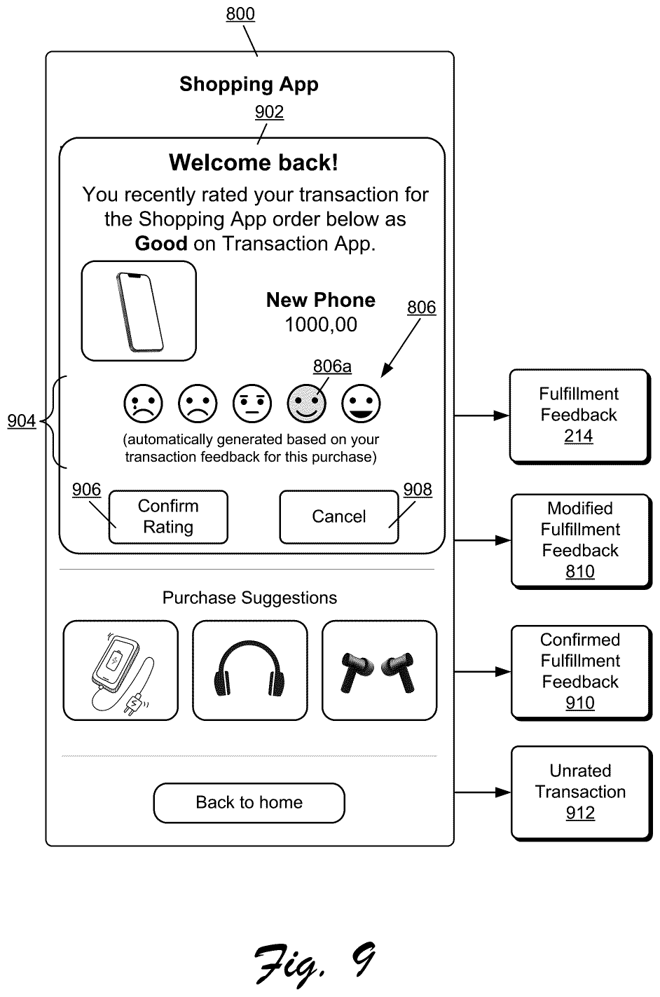

FIG. 9 depicts an example of the fulfillment GUI 800 in accordance with one or more implementations. In this example the fulfillment GUI 800 is presented when the user 110 returns to the fulfillment application 112 after having not previously confirmed the automatically generated fulfillment feedback 214 and/or having not provided modified fulfillment feedback 810.

The fulfillment GUI 800 includes a feedback window 902 that is presented to enable the user 110 to confirm the fulfillment feedback 214 and/or generate the modified fulfillment feedback 810. The feedback window 902, for instance, is generated and presented in response to the fulfillment service 104 and/or the fulfillment application 112 determining that the previously generated fulfillment feedback 214 has not been confirmed. The feedback window 902 includes a feedback region 904 with the feedback indicia 806 including the feedback indicator 806a which represents a visual representation of the fulfillment feedback 214. As discussed previously, each of the feedback indicia 806 are selectable to modify the fulfillment feedback 214 and generate the modified fulfillment feedback 810.

The feedback window 902 also includes a confirm control 906 and a cancel control 908. The confirm control 906 is selectable to confirm fulfillment feedback indicated by and/or provided to the feedback region 904. For instance, selection of the confirm control 906 causes the fulfillment feedback 214 and/or the modified fulfillment feedback 810 to be applied to the fulfillment transaction 204 to generate confirmed fulfillment feedback 910. The confirmed fulfillment feedback 910, for instance, is mapped to the fulfillment transaction 204 and stored as part of a data record of the fulfillment transaction 204. The cancel control 908 is selectable to cancel feedback confirmation. For instance, selection of the cancel control 908 causes the feedback window 902 to be removed from display and in at least some implementations, marks the fulfillment transaction as an unrated transaction 912 and causes a data record for the fulfillment transaction 204 to remain unassociated with feedback e.g., unrated.

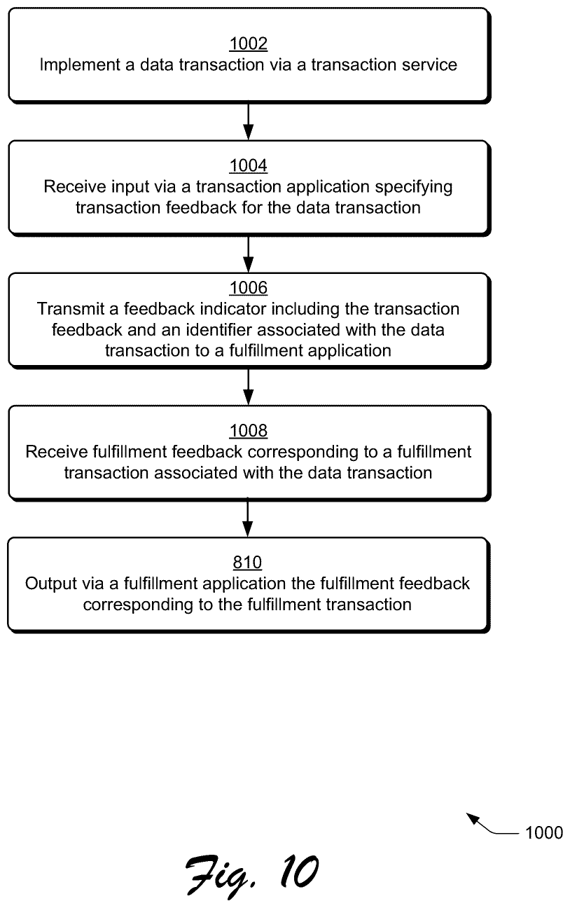

FIG. 10 illustrates a flow chart depicting an example method 1000 for feedback for different transaction types in accordance with one or more implementations. Operations of the method 1000, for instance, may be performed in the context of the environment 100, such as by the client device 102.

At 1002 a data transaction is implemented via a transaction service. The user 110, for instance, interacts with the fulfillment service 104 to perform a fulfillment transaction and a corresponding data transaction is implemented via the transaction service 106. At 1004 input is received via a transaction application specifying transaction feedback for the data transaction. The user 110, for example, interacts with the transaction application 114 to provide transaction feedback for the data transaction.

At 1006 a feedback indicator including the transaction feedback and an identifier associated with the data transaction is transmitted to a fulfillment application. For instance, the transaction application 114 transmits the feedback indicator to the fulfillment application 112. At 1008 fulfillment feedback corresponding to a fulfillment transaction associated with the data transaction is received. The client device 102, for example, receives fulfillment feedback from the fulfillment service 104. At 1010 the fulfillment feedback corresponding to the fulfillment transaction is output via a fulfillment application. The fulfillment application 112, for instance, outputs the fulfillment feedback via a GUI. Various examples of a fulfillment GUI are presented in the accompanying figures and described above.

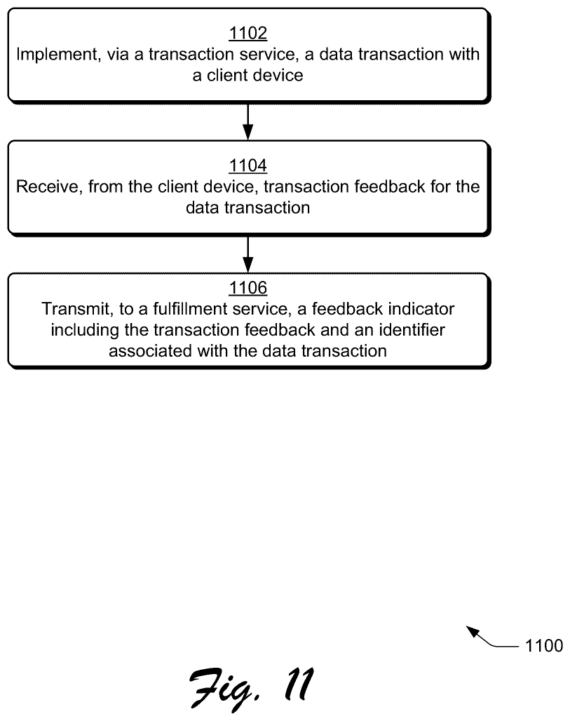

FIG. 11 illustrates a flow chart depicting an example method 1100 for feedback for different transaction types in accordance with one or more implementations. Operations of the method 1100, for instance, may be performed in the context of the environment 100, such as by the transaction service 106.

At 1102 a data transaction with a client device is implemented via a transaction service. As part of a fulfillment transaction, for instance, the transaction service 106 implements a data transaction via the client device 102. At 1104 transaction feedback for the data transaction is received from the client device. The user 110, for instance, provides transaction feedback for the data transaction via the transaction application 114. At 1106 a feedback indicator including the transaction feedback and an identifier associated with the data transaction is transmitted to a fulfillment service. The transaction service 106, for instance, transmits the feedback indicator to the fulfillment service 104.

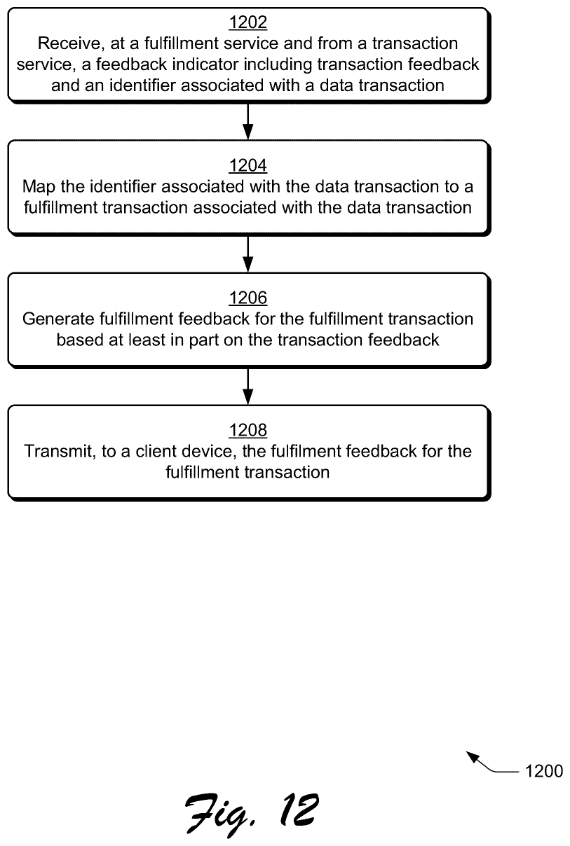

FIG. 12 illustrates a flow chart depicting an example method 1200 for feedback for different transaction types in accordance with one or more implementations. Operations of the method 1200, for instance, may be performed in the context of the environment 100, such as by the fulfillment service 104.

At 1202 a feedback indicator including transaction feedback and an identifier associated with a data transaction is received at a fulfillment service and from a transaction service. The fulfillment service 104, for instance, receives the feedback indicator from the transaction service 106. At 1204 the identifier associated with the data transaction is mapped to a fulfillment transaction associated with the data transaction. The fulfillment service 104, for example, uses an identifier for the data transaction and/or the fulfillment transaction to map the fulfillment transaction to the data transaction.

At 1206 fulfillment feedback for the fulfillment transaction is generated based at least in part on the transaction feedback. The fulfillment service 104, for instance, generates fulfillment feedback based on the transaction feedback. In at least one implementation the fulfillment service 104 performs a data transformation to transform the transaction feedback into a different feedback form used by the fulfillment service 104 to generate the fulfillment feedback.

At 1208 the fulfilment feedback for the fulfillment transaction is transmitted to a client device. For example, the fulfillment service 104 transmits the fulfillment feedback to the client device 102 and the client device 102 can output the fulfillment feedback, such as via the fulfillment application 112.

The example methods described above may be performed in various ways, such as for implementing various aspects of the systems and scenarios described herein. Any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 13 illustrates various components of an example device 1300 in which aspects of feedback for different transaction types can be implemented. The example device 1300 can be implemented as any of the devices described with reference to the previous FIGS. 1-12, such as any type of mobile device, mobile phone, mobile device, wearable device, tablet, computing, communication, entertainment, gaming, media playback, and/or other type of electronic device. For example, the client device 102, the fulfillment service 104, and/or the transaction service 106 as shown and described with reference to FIGS. 1-12 may be implemented as the example device 1300.

The device 1300 includes communication transceivers 1302 that enable wired and/or wireless communication of device data 1304 with other devices. The device data 1304 can include any of device identifying data, device location data, wireless connectivity data, and wireless protocol data. Additionally, the device data 1304 can include any type of audio, video, and/or image data. Example communication transceivers 1302 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 1300 may also include one or more data input ports 1306 via which any type of data, media content, and/or inputs can be received, such as user selectable-inputs to the device, messages, music, television content, recorded content, and any other type of audio, video, and/or image data received from any content and/or data source. The data input ports may include USB (Universal Serial Bus) ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1300 includes a processing system 1308 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are identified at 1310. The device 1300 may further include any type of a system bus or other data and command transfer system that couples the various components within the device. A system bus can include any one or combination of different bus structures and architectures, as well as control and data lines.

The device 1300 also includes computer-readable storage memory 1312 (e.g., memory devices) that enable data storage, such as data storage devices that can be accessed by a computing device, and that provide persistent storage of data and executable instructions (e.g., software applications, programs, functions, and the like). Examples of the computer-readable storage memory 1312 include volatile memory and non-volatile memory, fixed and removable media devices, and any suitable memory device or electronic data storage that maintains data for computing device access. The computer-readable storage memory can include various implementations of random access memory (RAM), read-only-memory (ROM), flash memory, and other types of storage media in various memory device configurations. The device 1300 may also include a mass storage media device.

The computer-readable storage memory 1312 provides data storage mechanisms to store the device data 1304, other types of information and/or data, and various device applications 1314 (e.g., software applications). For example, an operating system 1316 can be maintained as software instructions with a memory device and executed by the processing system 1308. The device applications may also include a device manager, such as any form of a control application, software application, signal-processing and control module, code that is native to a particular device, a hardware abstraction layer for a particular device, and so on. Computer-readable storage memory 1312 represents media and/or devices that enable persistent and/or non-transitory storage of information in contrast to mere signal transmission, carrier waves, or signals per se. Computer-readable storage memory 1312 do not include signals per se or transitory signals.

In this example, the device 1300 includes a feedback service 1318 that implements aspects of feedback for different transaction types and may be implemented with hardware components and/or in software as one of the device applications 1314. For example, the feedback service 1318 can be implemented via the client device 102, the fulfillment service 104, the transaction service 106, and/or via the application ecosystem 136. The feedback service 1318, for instance, can represent an implementation of the fulfillment feedback service 120 and/or the transaction feedback service 128. In implementations, the feedback service 1318 may include independent processing, memory, and logic components as a computing and/or electronic device integrated with the device 1300. The device 1300 also includes feedback data 1320 for implementing aspects of feedback for different transaction types and may include data from the feedback service 1318, such as data for managing transaction feedback.

In this example, the example device 1300 also includes a camera 1322 and motion sensors 1324, such as may be implemented in an inertial measurement unit (IMU). The motion sensors 1324 can be implemented with various sensors, such as a gyroscope, an accelerometer, and/or other types of motion sensors to sense motion of the device. The various motion sensors 1324 may also be implemented as components of an inertial measurement unit in the device.

The device 1300 also includes a wireless module 1326, which is representative of functionality to perform various wireless communication tasks. The device 1300 can also include one or more power sources 1328, such as when the device is implemented as a mobile device. The power sources 1328 may include a charging and/or power system, and can be implemented as a flexible strip battery, a rechargeable battery, a charged super-capacitor, and/or any other type of active or passive power source.

The device 1300 also includes an audio and/or video processing system 1330 that generates audio data for an audio system 1332 and/or generates display data for a display system 1334. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1336. In implementations, the audio system and/or the display system are integrated components of the example device. Alternatively, the audio system and/or the display system are external, peripheral components to the example device.

Although implementations of feedback and feedback for different transaction types have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one processor; and one or more modules executable by the at least one processor to: implement a data transaction via a transaction service; receive input via a transaction application specifying transaction feedback for the data transaction; transmit a feedback indicator including the transaction feedback and an identifier associated with the data transaction to a fulfillment application; receive fulfillment feedback corresponding to a fulfillment transaction associated with the data transaction; and output via a fulfillment application the fulfillment feedback corresponding to the fulfillment transaction.

In some aspects, the techniques described herein relate to a client device, wherein the data transaction includes a payment for a purchase of a product and the transaction feedback is associated with the payment transaction.

In some aspects, the techniques described herein relate to a client device, wherein the one or more modules are executable by at least one processor to receive the fulfillment feedback from a fulfillment service.

In some aspects, the techniques described herein relate to a client device, wherein the one or more modules are executable by at least one processor to output the fulfillment feedback via a transaction application separate from the fulfilment application.

In some aspects, the techniques described herein relate to a client device, wherein to output the fulfillment feedback, the one or more modules are executable by the at least one processor to insert the fulfillment feedback into a fulfillment graphical user interface that includes transaction details for the fulfillment transaction.

In some aspects, the techniques described herein relate to a client device, wherein the one or more modules are executable by the at least one processor to output the fulfillment feedback based at least in part on a launch of the fulfillment application on the client device.

In some aspects, the techniques described herein relate to a client device, wherein the one or more modules are executable by the at least one processor to: output the fulfillment feedback as a proposed fulfillment feedback suggestion; and determine whether to store the fulfillment feedback based on whether user input is received to confirm the proposed fulfillment feedback suggestion.

In some aspects, the techniques described herein relate to a client device, wherein the one or more modules are executable by the at least one processor to output the fulfillment feedback via the fulfillment application independent of user input to specify the fulfillment feedback to the fulfillment application.

In some aspects, the techniques described herein relate to a client device, wherein the one or more modules are executable by the at least one processor to: output the transaction feedback via a first graphical user interface associated with the transaction application; and output the fulfillment feedback via a second graphical user interface associated with the fulfillment application.

In some aspects, the techniques described herein relate to a system including: at least one memory; and at least one processor coupled to the at least one memory and configured to cause the system to: implement, via a transaction service, a data transaction with a client device; receive, from the client device, transaction feedback for the data transaction; and transmit, to a fulfillment service, a feedback indicator including the transaction feedback and an identifier associated with the data transaction.

In some aspects, the techniques described herein relate to a system, wherein the data transaction includes a payment for a purchase of a product and the transaction feedback is associated with the said payment.

In some aspects, the techniques described herein relate to a system, wherein the feedback indicator further includes an identifier for the payment transaction.

In some aspects, the techniques described herein relate to a system, wherein the at least one processor is configured to cause the system to generate a transaction graphical user interface that identifies the data transaction and the transaction feedback for the data transaction.

In some aspects, the techniques described herein relate to a system, wherein the feedback indicator further includes a product transaction mapping that maps a payment associated with the data transaction to a fulfillment transaction associated with the data transaction.

In some aspects, the techniques described herein relate to a system including: at least one memory; and at least one processor coupled to the at least one memory and configured to cause the system to: receive, at a fulfillment service and from a transaction service, a feedback indicator including transaction feedback and an identifier associated with a data transaction; map the identifier associated with the data transaction to a fulfillment transaction associated with the data transaction; generate fulfillment feedback for the fulfillment transaction based at least in part on the transaction feedback; and transmit, to a client device, the fulfilment feedback for the fulfillment transaction.

In some aspects, the techniques described herein relate to a system, wherein the feedback indicator further includes an identifier for a payment associated with the fulfillment transaction.

In some aspects, the techniques described herein relate to a system, wherein the feedback indicator further includes mapping data for mapping the data transaction to the fulfillment transaction.

In some aspects, the techniques described herein relate to a system, wherein to generate the fulfilment feedback, at least one processor is configured to cause the system to map a first feedback type for the data transaction to a second feedback type for the fulfillment transaction.

In some aspects, the techniques described herein relate to a system, wherein one or more of the data transaction or the fulfillment transaction includes one or more of an exchange of data representing value or an exchange of sensitive data.

In some aspects, the techniques described herein relate to a system, wherein the fulfillment feedback includes an association of the fulfillment feedback with a payment associated with the data transaction and the fulfillment transaction.

1. A client device comprising:
at least one processor; and
one or more modules executable by the at least one processor to:
implement a data transaction via a transaction service;
receive input via a transaction application specifying transaction feedback for the data transaction;
transmit a feedback indicator including the transaction feedback and an identifier associated with the data transaction to a fulfillment application;
receive fulfillment feedback corresponding to a fulfillment transaction associated with the data transaction; and
output via a fulfillment application the fulfillment feedback corresponding to the fulfillment transaction.

2. The client device of claim 1, wherein the data transaction comprises a payment for a purchase of a product and the transaction feedback is associated with the payment transaction.

3. The client device of claim 1, wherein the one or more modules are executable by at least one processor to receive the fulfillment feedback from a fulfillment service.

4. The client device of claim 1, wherein the one or more modules are executable by at least one processor to output the fulfillment feedback via a transaction application separate from the fulfilment application.

5. The client device of claim 1, wherein to output the fulfillment feedback, the one or more modules are executable by the at least one processor to insert the fulfillment feedback into a fulfillment graphical user interface that includes transaction details for the fulfillment transaction.

6. The client device of claim 1, wherein the one or more modules are executable by the at least one processor to output the fulfillment feedback based at least in part on a launch of the fulfillment application on the client device.

7. The client device of claim 6, wherein the one or more modules are executable by the at least one processor to:
output the fulfillment feedback as a proposed fulfillment feedback suggestion; and
determine whether to store the fulfillment feedback based on whether user input is received to confirm the proposed fulfillment feedback suggestion.

8. The client device of claim 1, wherein the one or more modules are executable by the at least one processor to output the fulfillment feedback via the fulfillment application independent of user input to specify the fulfillment feedback to the fulfillment application.

9. The client device of claim 1, wherein the one or more modules are executable by the at least one processor to:
output the transaction feedback via a first graphical user interface associated with the transaction application; and
output the fulfillment feedback via a second graphical user interface associated with the fulfillment application.

10-20. (canceled)

21. A method at a client device, comprising:
implementing a data transaction via a transaction service;
receiving input via a transaction application specifying transaction feedback for the data transaction;
transmitting a feedback indicator including the transaction feedback and an identifier associated with the data transaction to a fulfillment application;
receiving fulfillment feedback corresponding to a fulfillment transaction associated with the data transaction; and
outputting, via a fulfillment application, the fulfillment feedback corresponding to the fulfillment transaction.

22. The method of claim 21, wherein the data transaction comprises a payment for a purchase of a product and the transaction feedback is associated with the payment transaction.

23. The method of claim 21, further comprising receiving the fulfillment feedback from a fulfillment service.

24. The method of claim 21, further comprising outputting the fulfillment feedback via a transaction application separate from the fulfilment application.

25. The method of claim 21, wherein outputting the fulfillment feedback comprises inserting the fulfillment feedback into a fulfillment graphical user interface that includes transaction details for the fulfillment transaction.

26. The method of claim 21, further comprising outputting the fulfillment feedback based at least in part on a launch of the fulfillment application on the client device.

27. The method of claim 26, further comprising:
outputting the fulfillment feedback as a proposed fulfillment feedback suggestion; and
determining whether to store the fulfillment feedback based on whether user input is received to confirm the proposed fulfillment feedback suggestion.

28. The method of claim 21, further comprising outputting the fulfillment feedback via the fulfillment application independent of user input to specify the fulfillment feedback to the fulfillment application.

29. The method of claim 21, further comprising:
outputting the transaction feedback via a first graphical user interface associated with the transaction application; and
outputting the fulfillment feedback via a second graphical user interface associated with the fulfillment application.

30. A system comprising:
at least one memory; and
at least one processor coupled with the at least one memory and configured to cause the system to:
implement a data transaction via a transaction service;
receive input via a transaction application specifying transaction feedback for the data transaction;
transmit a feedback indicator including the transaction feedback and an identifier associated with the data transaction to a fulfillment application;
receive fulfillment feedback corresponding to a fulfillment transaction associated with the data transaction; and
output via a fulfillment application the fulfillment feedback corresponding to the fulfillment transaction.

31. The system of claim 30, wherein the data transaction comprises a payment for a purchase of a product and the transaction feedback is associated with the payment transaction.
